(19) United States
(12) Patent Application Publication
(10) Pub. No.: US 2020/0378817 A1
(43) Pub. Date: Dec. 3, 2020

(54) ULTRASONIC POSITION DETECTION TEMPERATURE CALIBRATION

(71) Applicant: Hamilton Sundstrand Corporation, Charlotte, NC (US)

(72) Inventors: Ashish Vijay, Bikaner (IN); Udaya Rani, Tamil Nadu (IN); Anil Prasad Josyula, Vijayawada (IN); Harish Venkatesha, Davangere (IN)

(21) Appl. No.: 16/518,411

(22) Filed: Jul. 22, 2019

(30) Foreign Application Priority Data
May 27, 2019 (IN) 201911020943

(51) Int. Cl. G01F 23/296; G01S 7/486

(52) U.S. Cl. CPC G01F 23/2962; G01S 17/00; G01S 7/4865

(57) ABSTRACT

Disclosed is a piston position control system that includes a fluid control valve configured to control a position of a piston. The piston position control system includes a controller having stored instructions operable to receive a piston position command. The stored instructions are operable to receive a first time-of-flight and a second time-of-flight. The stored instructions are operable to operate the fluid control valve to adjust the position of the piston according to the piston position command based on a position estimate defined by the first time-of-flight, t₁ and the second time-of-flight, t₂. The stored instructions are operable to adjust the position estimate to operate the fluid control valve based on a baseplate temperature derived from a fluid temperature defined by the first time-of-flight and the second time-of-flight.

### CROSS REFERENCE TO RELATED APPLICATIONS

This application claims the benefit of Indian Application No. 201911020943, filed May 27, 2019, which is incorporated by reference in its entirety herein.

### BACKGROUND

Exemplary embodiments pertain to the art of position estimation for actuator pistons. Ultrasonic sensors may be used to determine actuator distance and measure system parameters that may otherwise be unavailable.

### BRIEF DESCRIPTION

Disclosed is a piston position control system that includes a fluid control valve configured to control a position of a piston. The piston position control system includes a controller having stored instructions operable to receive a piston position command. The stored instructions are operable to receive a first time-of-flight and a second time-of-flight. The stored instructions are operable to operate the fluid control valve to adjust the position of the piston according to the piston position command based on a position estimate defined by the first time-of-flight, t₁ and the second time-of-flight, t₂. The stored instructions are operable to adjust the position estimate to operate the fluid control valve based on a baseplate temperature derived from a fluid temperature defined by the first time-of-flight and the second time-of-flight.

In addition to one or more of the features described above, or as an alternative, further embodiments may include an ultrasonic transceiver configured to output a first acoustic signal and define the first time-of-flight based on a first echo associated with the first acoustic signal.

In addition to one or more of the features described above, or as an alternative, further embodiments may include that the piston is disposed in a cylinder having a baseplate associated with the baseplate temperature.

In addition to one or more of the features described above, or as an alternative, further embodiments may include that the cylinder houses fluid associated with the fluid temperature.

In addition to one or more of the features described above, or as an alternative, further embodiments may include that a baseplate material composition of the baseplate includes aluminum.

In addition to one or more of the features described above, or as an alternative, further embodiments may include that the piston includes a head defining a step having a height, h, and the position estimate is calculated according to a thickness, L, of the baseplate, a transmission speed, v_{P}, associated with the baseplate, and the height.

In addition to one or more of the features described above, or as an alternative, further embodiments may include that the position estimate is equal to

$$( {t}_{1} - \frac{L}{{v}_{P}} ) * \frac{h}{( {t}_{2} - {t}_{1} )} .$$

In addition to one or more of the features described above, or as an alternative, further embodiments may include that the fluid temperature is based on a fluid lookup table that defines the fluid temperature with respect to the first time-of-flight and the second time-of-flight.

In addition to one or more of the features described above, or as an alternative, further embodiments may include that the baseplate temperature is based on a baseplate temperature lookup table that defines the baseplate temperature with respect to the fluid temperature.

In addition to one or more of the features described above, or as an alternative, further embodiments may include that a piston material composition of the piston includes Steel.

Also disclosed is a method that includes receiving a position command. The method includes receiving a first time-of-flight, t₁, and a second time-of-flight, t₂. The method includes operating a fluid control valve to adjust a position of a piston according to the position command. The operation is based on a position estimate associated with the position defined by the first time-of-flight, t₁, and the second time-of-flight, t₂. The operation is adjusted according to a baseplate temperature derived from a fluid temperature defined by the first time-of-flight and the second time-of-flight.

In addition to one or more of the features described above, or as an alternative, further embodiments may include outputting a first acoustic signal and defining the first time-of-flight based on a first echo associated with the first acoustic signal.

In addition to one or more of the features described above, or as an alternative, further embodiments may include that the position estimate is equal to

$$( {t}_{1} - \frac{L}{{v}_{P}} ) * \frac{h}{( {t}_{2} - {t}_{1} )} ,$$

where h is a height of a step of a head of the piston, L is a thickness of a baseplate associated with a cylinder associated with the piston, and v_{P} is a transmission speed associated with the baseplate.

In addition to one or more of the features described above, or as an alternative, further embodiments may include that the fluid temperature is based on a fluid lookup table that defines the fluid temperature with respect to the first time-of-flight and the second time-of-flight.

In addition to one or more of the features described above, or as an alternative, further embodiments may include that the baseplate temperature is based on a baseplate temperature lookup table that defines the baseplate temperature with respect to the fluid temperature.

Also disclosed is a hydraulic control system. The hydraulic system includes a controller having stored instructions operable to receive a position command. The instructions are operable to receive a first time-of-flight and a second time-of-flight. The instructions are operable to operate a fluid control valve to adjust a position of a piston according to the position command based on a position estimate associated with the position defined by the first time-of-flight, t₁, and the second time-of-flight, t₂, and according to a baseplate temperature derived from a fluid temperature defined by the first time-of-flight and the second time-of-flight.

In addition to one or more of the features described above, or as an alternative, further embodiments may include that the fluid temperature is based on a fluid lookup table that defines the fluid temperature with respect to the first time-of-flight and the second time-of-flight.

In addition to one or more of the features described above, or as an alternative, further embodiments may include that the baseplate temperature is based on a baseplate temperature lookup table that defines the baseplate temperature with respect to the fluid temperature.

In addition to one or more of the features described above, or as an alternative, further embodiments may include that a cylinder associated with hydraulic piston having a baseplate associated with the baseplate temperature.

In addition to one or more of the features described above, or as an alternative, further embodiments may include that the hydraulic piston includes a head defining a step having a height, h, and the position estimate is calculated according to a thickness, L, of the baseplate, a transmission speed, v_{P}, associated with the baseplate, and the height and equal to

$$( {t}_{1} - \frac{L}{{v}_{P}} ) * \frac{h}{( {t}_{2} - {t}_{1} )} .$$

### BRIEF DESCRIPTION OF THE DRAWINGS

The following descriptions should not be considered limiting in any way. With reference to the accompanying drawings, like elements are numbered alike:

FIG. 1 is a schematic of an ultrasonic based position control system; and

FIG. 2 is a method for implementing an ultrasonic based position control system.

### DETAILED DESCRIPTION

A detailed description of one or more embodiments of the disclosed apparatus and method are presented herein by way of exemplification and not limitation with reference to the Figures.

Fluid actuators may be implemented to change machinery or component position. For example, fluid actuators may be implemented on aircraft to position numerous components. As one example, a fluid actuator may be used to adjust landing gear position. One such fluid actuator may be a fluid operated piston. Pistons may provide linear motion to actuate or position components. Pistons may be disposed within a cylinder housing that contains a pressurized gaseous or liquidous fluid.

An ultrasonic sensor may be positioned on a baseplate of the cylinder to bounce ultrasonic waves off of a head of the piston. The echo of the ultrasonic waves can provide a time-of-flight distance measurement based on the known propagation velocity of the ultrasonic waves through the fluid and the baseplate. As environmental conditions of the cylinder change, the temperature of the fluid and the baseplate may add error or uncertainty to the position measurement due to changes in the propagation velocity through the disparate mediums.

A step on the head of the piston may provide temperature compensation for the fluid because the propagation velocity through the fluid can be determined if a height of the step is known. The temperature may be determined by the propagation velocity. The fluid temperature may be used to determine the baseplate temperature. As such, the propagation velocity through the baseplate may be determined based on baseplate temperature. That is, the valve may be operated based on the position estimate for the piston as adjusted based on the temperature of both the baseplate and the fluid.

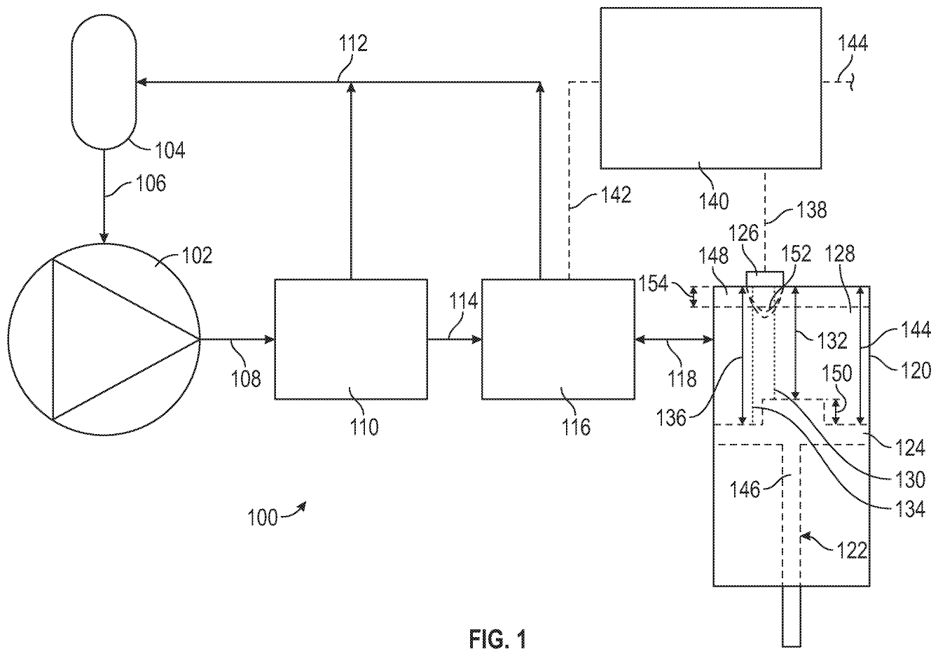

Referring to FIG. 1, a piston position control system or hydraulic control system 100 is shown. The piston position control system 100 includes a pump 102. The pump 102 may draw fluid (e.g., hydraulic or pneumatic) from accumulator or reservoir 104 through pipe 106. The pump outlet pipe 108 supplies pressurized fluid to the cylinder cavity 128 according to relieve valve 110 and fluid control valve 116. The relief valve 110 may allow the transfer of fluid from the pump outlet pipe 108 to the fluid control valve 116 unless pump outlet pipe 108 pressure rises above the relieve valve 110 setpoint. If the pressure rises above the setpoint, the relief valve 110 opens to discharge fluid through relief return pipe 112.

The fluid control valve 116 is configured to control a position 144 of the piston 122 with respect to the ultrasonic transceiver 126 by adjusting the flow of fluid through control valve outlet pipe 118. The piston 122 may be made of steel or another metallic material or alloy. The piston 122 may include a stem portion 146 and a head portion 124. The head portion 124 may include a step 150 for causing a time delay between a first echo 130 and a second echo 134. It should be appreciated that the position 144 may be defined with respect to any portion of the piston 122.

The fluid control valve 116 may be any type of control valve, including solenoid operated valves. The fluid control valve 116 may be a directional valve, providing directional flow into and out of the cylinder cavity 128. The fluid control valve 116 may be a 3/2 valve. The fluid control valve 116 may receive control input via cable 142 connected to controller 140. The controller 140 may operate the fluid control valve 116 through electrical signals, which may be either digital or analog and traverse any communications medium (e.g., copper, wireless). For example, the controller may directly control the position of the fluid control valve 116 by providing a direct current configured to operate a solenoid of the fluid control valve 116.

The controller 140 may include any combination of processors, field programmable gate arrays (FPGA), or application specific integrated circuits (ASIC). The controller may include memory, volatile and non-volatile, operable to store machine instructions from the processors and other processing mechanisms to receive, calculate, and control devices, as necessary. Machine instructions may be stored (e.g., stored instructions, stored machine instructions, stored steps) in any language or representation, including but not limited to machine code, assembly instructions, C, C++, C#, PASCAL, COBAL, PYTHON, JAVA, and RUBY. It should be appreciated that any type of wired or wireless configuration is appreciated for any of the communications from the controller. Wireless protocols such as ZIGBEE, WI-FI, BLUETOOTH, or any other implement may be used. Communications may be realized through any protocol or medium known or unknown.

The controller 140 may receive a position command 144 from another source or internally receive position commands based on stored programming. The position command 144 may be a relative distance between the transceiver 126 and the piston head 124.

The ultrasonic transceiver 126 may be any type of ultrasonic transmitter, receiver, or combination thereof. The ultrasonic transceiver may output a first acoustic signal 152 in the form of waves or other energy forms having a predetermined propagation or transmission speed (e.g., meters per second). The ultrasonic transceiver 126 outputs an ultrasonic wave and receives echoes 130, 134. As shown, the echoes 130, 134 correspond to respective distances 132, 136. The ultrasonic wave and echoes 130, 134 are received at different times due to the time-of-flight of the respective echoes 130, 134. For example, the first time-of-flight, t₁ is the time it takes for the echo 130 to return to the ultrasonic transceiver 126 after being sent from the ultrasonic transceiver 126. The second time-of-flight, t₂ is the time it takes for the echo 134 to return to the ultrasonic transceiver 126 after being sent from the ultrasonic transceiver 126. The time may be based on a number of digital clock cycles of the transceiver 126. It should be appreciated that multiple ultrasonic transceivers 126 may be used to send or receive any of the signals discussed. Additional ultrasonic transceivers 126 may also be used for redundancy.

The echoes 130, 134 may reflect off of the head portion 124 according to respective distances 132, 136 defined by step 150 and traverse both the fluid in the cylinder cavity 128 and the baseplate 148. The baseplate may be disposed within the cylinder 120. The baseplate may have thickness, L, 154. The baseplate 148 may be a similar material to the cylinder 120 or the piston 122. The baseplate 148 may have a distinct baseplate material composition. The baseplate 148 may be composed at least in part by aluminum. That is, the baseplate 148 has a material composition that includes aluminum. The baseplate 148 may alter the first time-of-flight and the second time-of-flight differently than the fluid within the cylinder cavity 128. That is, the wave propagation—and time-of-flight over distances 132, 136—through the fluid within the cylinder cavity 128 may be different between the two mediums. Temperature fluctuations of the two mediums may further alter the propagation of waves and echoes 130, 134 through the fluid in the cylinder cavity 128 and the baseplate 148.

The first time-of-flight, t₁ and the second time-of-flight, t₂ may be sent to the controller 140 via transmission cable 138. The transmission cable 138 may be analog or digital and traverse any communications medium (e.g., copper, wireless). It should be appreciated that any number of calculations or determinations may be performed by any one of the fluid control valve 116, the ultrasonic transceiver 126, and the controller 140.

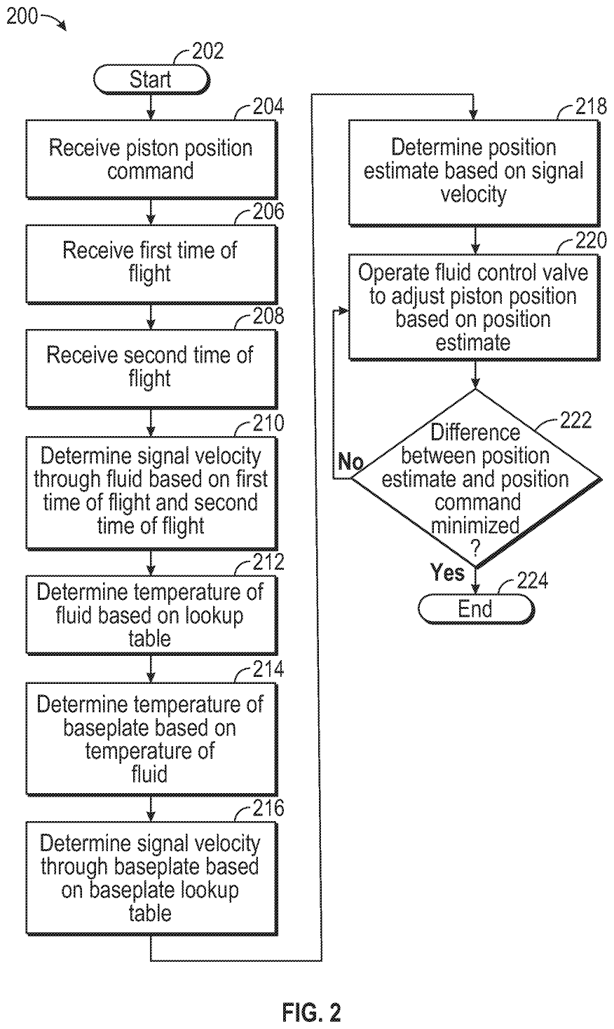

Referring to FIG. 2, a method 200 is shown. It should be appreciated that any of the steps may be omitted, reordered, repeated, or completed in parallel. Any of the components disclosed may perform any, all, or none of the mentioned steps herein. The method 200 begins in step 202. In step 204, a piston position command is received. The piston position command may be determined internally or received from an outside source. In step 206, a first time-of-flight is received. In step 208 a second time-of-flight is received. In step 210, the signal velocity, propagation velocity, or waveform propagation velocity is determined based on a difference of the first time-of-flight and the second time-of-flight. For example, the controller 140 or ultrasonic transducer may record a sent timestamp associated with transmitting the ultrasonic wave and record a received timestamp associated with receiving the ultrasonic echoes 130, 134. As such, the signal velocity through the fluid can be calculated by a difference between the first time-of-flight and the second time-of-flight because the step 150 is known.

In step 212, the temperature of the fluid within the cylinder cavity 128 is determined based on an equation, lookup table, or another implement. For example, the fluid lookup table may include entries for various temperatures as associated with various signal velocities in the relevant medium. The temperature may also be determined based on a representative equation associating temperatures and signal propagation values. As such, the controller 140 or another implement may determine the temperature of the fluid within the cylinder cavity 128.

In step 214, the temperature of the baseplate 148 is determined as being similar to the temperature of the fluid within the cylinder cavity 128. The temperature of the baseplate 148 may be exactly the same temperature as the fluid within the cylinder cavity 128 or a predetermined offset may be used to compensate for typical temperatures of the surrounding environment. In step 216, the signal velocity through the baseplate 148 is determined based on an equation, lookup table, or another implement. For example, the baseplate temperature lookup table may include entries for various temperatures as associated with various signal velocities associated with the baseplate medium. The signal velocity may also be determined based on a representative equation associating temperatures and signal velocity values. As such, the controller 140 or another implement may determine the signal velocity in the baseplate 148. In step 218, the position estimate of head 124 is determined based on the signal velocity through the fluid within the cylinder cavity 128 and the signal velocity through the baseplate 148. That is, the position estimate is adjusted to compensate for temperature effects altering the signal propagation through both the fluid in the cylinder cavityl28 and the baseplate 148. In step 220, the controller 140 operates the fluid control valve 116 to adjust piston position based on the position estimate to minimize a difference between the position command 144 and the position estimate. In step 222, the difference between the position command 144 and the position estimate is minimized or reduced within a deadband. The deadband may be based on the temperature of the baseplate 148. As an example, the deadband may increase as temperatures associated with the baseplate 148 diverge from normal operating temperature or temperatures at the extremes of the lookup tables used in steps 210-216. In step 224, the processes repeats or ends.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A piston position control system comprising:
a fluid control valve configured to control a position of a piston; and
a controller having stored instructions operable to:
receive a piston position command;
receive a first time-of-flight and a second time-of-flight; and
operate the fluid control valve to adjust the position of the piston according to the piston position command based on a position estimate defined by the first time-of-flight, t₁ and the second time-of-flight, t₂;
adjust the position estimate to operate the fluid control valve based on a baseplate temperature derived from a fluid temperature defined by the first time-of-flight and the second time-of-flight.

2. The piston position control system of claim 1, further comprising an ultrasonic transceiver configured to output a first acoustic signal and define the first time-of-flight based on a first echo associated with the first acoustic signal.

3. The piston position control system of claim 1 wherein the piston is disposed in a cylinder having a baseplate associated with the baseplate temperature.

4. The piston position control system of claim 3, wherein the cylinder houses fluid associated with the fluid temperature.

5. The piston position control system of claim 3, wherein a baseplate material composition of the baseplate includes aluminum.

6. The piston position control system of claim 3, wherein the piston includes a head defining a step having a height, h, and the position estimate is calculated according to a thickness, L, of the baseplate, a transmission speed, v_{P}, associated with the baseplate, and the height.

7. The piston position control system of claim 6, wherein the position estimate is equal to
$$( {t}_{1} - \frac{L}{{v}_{P}} ) * \frac{h}{( {t}_{2} - {t}_{1} )} .$$

8. The piston position control system of claim 1, wherein the fluid temperature is based on a fluid lookup table that defines the fluid temperature with respect to the first time-of-flight and the second time-of-flight.

9. The piston position control system of claim 1, wherein the baseplate temperature is based on a baseplate temperature lookup table that defines the baseplate temperature with respect to the fluid temperature.

10. The piston position control system of claim 1, wherein a piston material composition of the piston includes steel.

11. A method comprising:
receiving a position command;
receiving a first time-of-flight, t₁, and a second time-of-flight, t₂
operating a fluid control valve to adjust a position of a piston according to the position command
based on a position estimate associated with the position defined by the first time-of-flight, t₁, and the second time-of-flight, t₂, and
adjusted according to a baseplate temperature derived from a fluid temperature defined by the first time-of-flight and the second time-of-flight.

12. The method of claim 11, further comprising outputting a first acoustic signal and defining the first time-of-flight based on a first echo associated with the first acoustic signal.

13. The method of claim 11, wherein the position estimate is equal to
$$( {t}_{1} - \frac{L}{{v}_{P}} ) * \frac{h}{( {t}_{2} - {t}_{1} )} ,$$
where h is a height of a step of a head of the piston, L is a thickness of a baseplate associated with a cylinder associated with the piston, and v_{P} is a transmission speed associated with the baseplate.

14. The method of claim 11, wherein the fluid temperature is based on a fluid lookup table that defines the fluid temperature with respect to the first time-of-flight and the second time-of-flight.

15. The method of claim 11, wherein the baseplate temperature is based on a baseplate temperature lookup table that defines the baseplate temperature with respect to the fluid temperature.

16. A hydraulic control system comprising:
a controller having stored instructions operable to
receive a position command,
receive a first time-of-flight and a second time-of-flight, and
operate a fluid control valve to adjust a position of a piston according to the position command based on a position estimate associated with the position defined by the first time-of-flight, t₁, and the second time-of-flight, t₂, and according to a baseplate temperature derived from a fluid temperature defined by the first time-of-flight and the second time-of-flight.

17. The hydraulic control system of claim 16, wherein the fluid temperature is based on a fluid lookup table that defines the fluid temperature with respect to the first time-of-flight and the second time-of-flight.

18. The hydraulic control system of claim 16, wherein the baseplate temperature is based on a baseplate temperature lookup table that defines the baseplate temperature with respect to the fluid temperature.

19. The hydraulic control system of claim 16, further comprising a cylinder associated with hydraulic piston having a baseplate associated with the baseplate temperature.

20. The hydraulic control system of claim 19, wherein the hydraulic piston includes a head defining a step having a height, h, and the position estimate is calculated according to a thickness, L, of the baseplate, a transmission speed, v_{P}, associated with the baseplate, and the height and equal to
$$( {t}_{1} - \frac{L}{{v}_{P}} ) * \frac{h}{( {t}_{2} - {t}_{1} )} .$$
